(19) United States
(12) Patent Application Publication
(10) Pub. No.: US 2022/0183116 A1
(43) Pub. Date: Jun. 9, 2022

(54) COOLING DEVICE AND COOKING SYSTEM

(71) Applicant: Mitsubishi Electric Corporation, Tokyo (JP)

(72) Inventor: Ikuro SUGA, Tokyo (JP)

(21) Appl. No.: 17/602,245

(22) PCT Filed: May 29, 2019
(86) PCT No.: PCT/JP2019/021366

§ 371 Date: Oct. 7, 2021

(51) Int. Cl. H05B 6/12; F25B 21/02; A47J 27/00

(52) U.S. Cl. CPC H05B 6/12; A47J 27/004; F25B 21/02

(57) ABSTRACT

A cooling device includes a cooling unit configured to be driven by electric power and to receive heat, a power supply unit configured to supply the electric power to the cooling unit, and a housing that accommodates the cooling unit and is attachable to a cooking container and removable from the cooking container.

### TECHNICAL FIELD

The present disclosure relates to a cooling device configured to cool a cooking container and a cooking system including the cooling device.

### BACKGROUND ART

Existing technologies provide electric temperature-controlled containers that each include a power receiving coil and a heat exchange element and that use wireless power supply (for example, refer to Patent Literature 1). An electric temperature-controlled container disclosed in Patent Literature 1 includes an inner container, an outer container, and a bottom cover. A power receiving coil is disposed at the bottom portion of the electric temperature-controlled container, and a planar heat exchange element is disposed on the side surface of the inner container so as to surround the inner container.

### CITATION LIST

### Patent Literature

Patent Literature 1: Japanese Unexamined Patent Application Publication No. 2015-231473

### SUMMARY OF INVENTION

### Technical Problem

The temperature-controlled container developed by the technology disclosed in Patent Literature 1 includes the heat exchange element, which is disposed on the inner side surface of the temperature-controlled container, and keeps liquid contained in the temperature-controlled container warm or cool. However, the temperature-controlled container disclosed in Patent Literature 1 lacks versatility because a cooking container, such as a cooking pot, other than the temperature-controlled container, which includes the heat exchange element, cannot be cooled.

The present disclosure addresses the above issues, and an object of the present disclosure is to provide a cooling device and a cooking system that can improve versatility.

### Solution to Problem

A cooling device according to an embodiment of the present disclosure includes a cooling unit configured to be driven by electric power and to receive heat, a power supply unit configured to supply the electric power to the cooling unit, and a housing that accommodates the cooling unit and is attachable to a cooking container and removable from the cooking container.

### Advantageous Effects of Invention

The cooling device according to an embodiment of the present disclosure includes the housing, which accommodates the cooling unit and is attachable to a cooking container and removable from the cooking container. Accordingly, a cooking container other than a container having a heat exchange element can be cooled, leading to versatility improvement.

### BRIEF DESCRIPTION OF DRAWINGS

FIG. 1 is a perspective view depicting a cooling device according to Embodiment 1.

FIG. 2 is a plan view depicting the cooling device according to Embodiment 1.

FIG. 3 is a block diagram depicting a configuration of the cooling device according to Embodiment 1.

FIG. 4 is a side elevation view schematically depicting a configuration of a cooling unit of the cooling device according to Embodiment 1.

FIG. 5 is a plan view depicting the cooling unit of the cooling device according to Embodiment 1.

FIG. 6 is a longitudinal sectional view schematically depicting how the cooling device is placed according to Embodiment 1.

FIG. 7 is a plan view depicting a cooling unit of a cooling device according to Modification 1 of Embodiment 1.

FIG. 8 is a plan view depicting the cooling device according to Modification 1 of Embodiment 1.

FIG. 9 is a side elevation view schematically depicting how the cooling device is placed according to Modification 1 of Embodiment 1.

FIG. 10 is a perspective view depicting a cooling device according to Modification 2 of Embodiment 1.

FIG. 11 is a block diagram depicting a configuration of a cooling device according to Modification 3 of Embodiment 1.

FIG. 12 is a plan view depicting a cooling device according to Embodiment 2.

FIG. 13 is a cross-sectional view schematically depicting how the cooling device is placed according to Embodiment 2.

FIG. 14 is a longitudinal sectional view schematically depicting how the cooling device is placed according to Embodiment 2.

FIG. 15 is a perspective view depicting a cooling device according to Modification 1 of Embodiment 2.

FIG. 16 is a longitudinal sectional view schematically depicting how the cooling device is placed according to Modification 1 of Embodiment 2.

FIG. 17 is a plan view depicting a cooling device according to Modification 2 of Embodiment 2.

FIG. 18 is a longitudinal sectional view schematically depicting how the cooling device is placed according to Modification 2 of Embodiment 2.

FIG. 19 is an exploded perspective view depicting an induction heating cooker of a cooking system according to Embodiment 3.

FIG. 20 is a plan view depicting a heating coil and a power transmitting coil of the induction heating cooker according to Embodiment 3.

FIG. 21 is a block diagram depicting a configuration of a cooling device according to Embodiment 3.

FIG. 22 is a block diagram depicting a configuration of the induction heating cooker according to Embodiment 3.

FIG. 23 is a diagram depicting a configuration of the cooling device and the induction heating cooker of the cooking system according to Embodiment 3.

FIG. 24 is a specific circuit diagram of the configuration depicted in FIG. 23.

FIG. 25 is a plan view depicting the cooling device according to Embodiment 3.

FIG. 26 is a longitudinal sectional view schematically depicting how the cooling device is placed according to Embodiment 3.

FIG. 27 is a diagram describing the sizes of the housing and the power receiving coil of the cooling device and the size of the heating coil of the induction heating cooker in the cooking system according to Embodiment 3.

FIG. 28 is a longitudinal sectional view schematically depicting how a cooling device is placed according to Modification 1 of Embodiment 3.

FIG. 29 is a plan view depicting a cooling device according to Modification 2 of Embodiment 3.

FIG. 30 is a longitudinal sectional view schematically depicting how the cooling device is placed according to Modification 2 of Embodiment 3.

FIG. 31 is a plan view depicting a heating coil of an induction heating cooker according to Modification 3 of Embodiment 3.

### DESCRIPTION OF EMBODIMENTS

Cooling devices and cooking systems according to embodiments of the present disclosure will be described hereinafter with reference to the drawings. The present disclosure is not limited to the embodiments described below, and various modifications are possible as long as they do not depart from the spirit of the disclosure. In addition, the present disclosure includes every possible combination of the configurations that are illustrated in the embodiments described below. Further, a cooling device and a cooking system depicted in each of the drawings represent an example of an apparatus for which the cooling devices and the cooking systems according to the embodiments of the present disclosure are used, and the cooling devices and the cooking systems depicted in the drawings are not intended to limit an apparatus to which the present disclosure is applied. In the following descriptions, terms indicating directions (for example, “upper”, “upward”, “above”, “lower”, “under”, “right”, “left”, “front”, and “back”) are used as appropriate to facilitate understanding, and these terms are used for illustration and not for limiting the present disclosure, Items denoted by the same reference sign in the drawings refer to the same items or equivalents, and the same reference sign is used in the entire description. Relative sizes, shapes, and other properties of components illustrated in the drawings sometimes differ from actual properties of the components.

### Embodiment 1

### (Configuration)

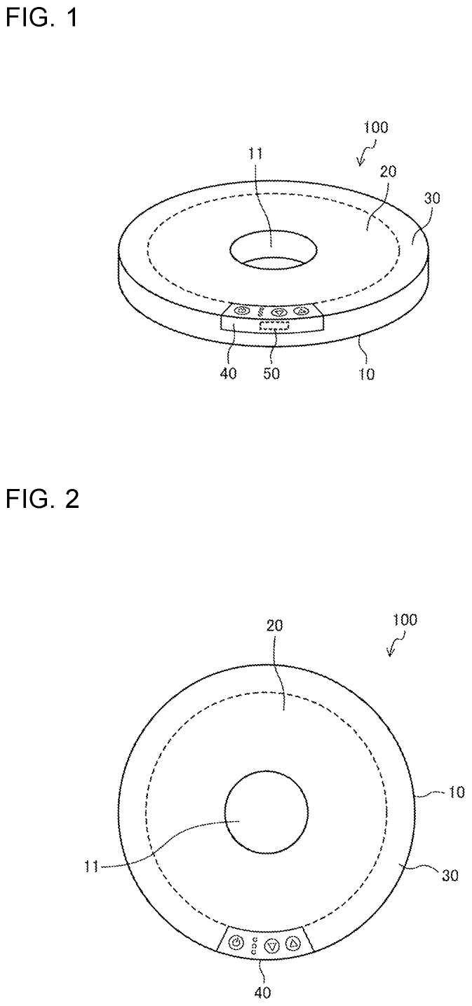

FIG. 1 is a perspective view depicting a cooling device according to Embodiment 1.

FIG. 2 is a plan view depicting the cooling device according to Embodiment 1.

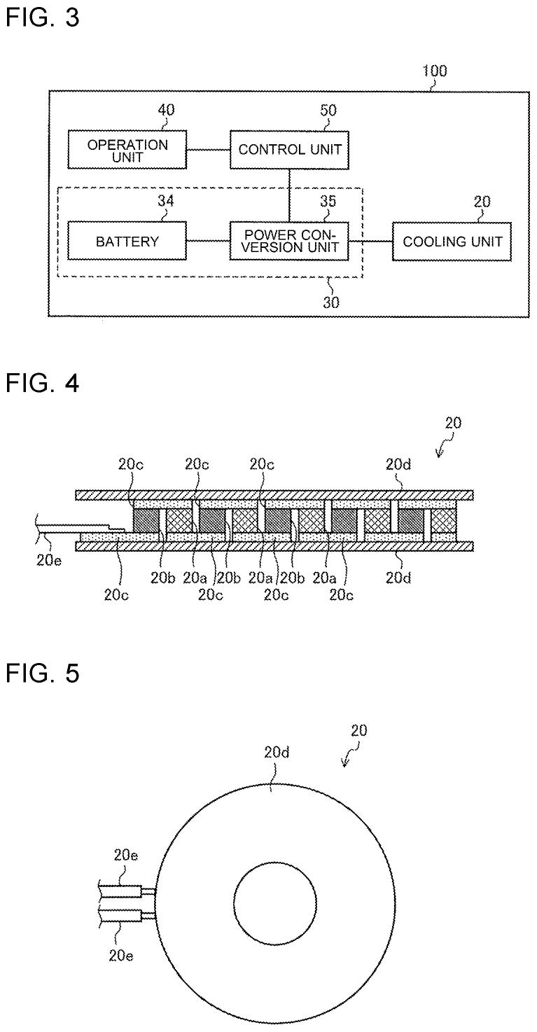

FIG. 3 is a block diagram depicting a configuration of the cooling device according to Embodiment 1.

As depicted in FIGS. 1 to 3, a cooling device 100 includes a housing 10, a cooling unit 20, a power supply unit 30, an operation unit 40, and a control unit 50.

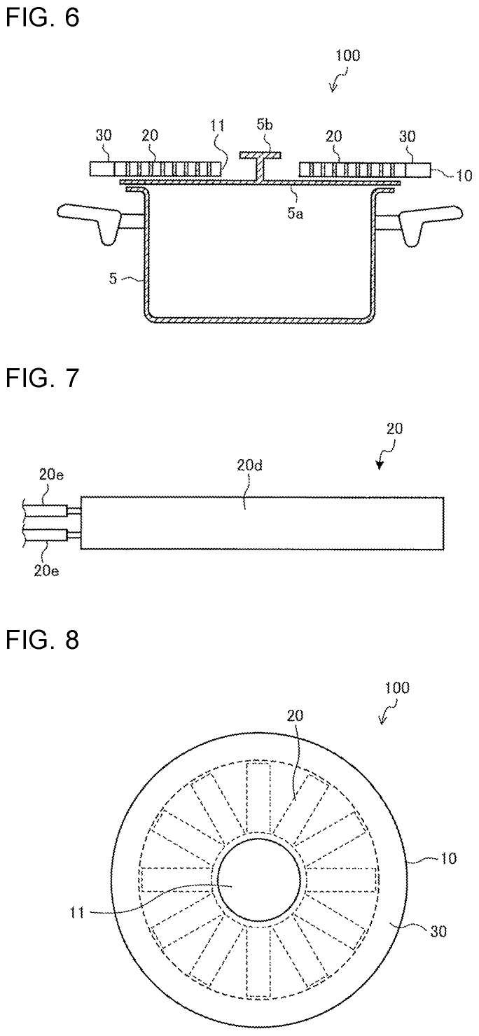

The housing 10 is attachable to a cooking container 5 and removable from the cooking container 5 (refer to FIG. 6). The housing 10 is formed, for example, into a disc-like shape. The housing 10 also has an opening 11 provided in the center. The housing 10 is made of any material, such as resin, metal, and compound material formed by resin and metal. The housing 10 is desirably made of material having a good heat-transfer property. The housing 10 accommodates the cooling unit 20 and the power supply unit 30. The power supply unit 30 is disposed at the outer perimeter portion of the housing 10, and the cooling unit 20 is disposed at the inner perimeter portion of the housing 10 and is located closer to the center of the housing 10 than is the power supply unit 30. Heat insulating material, which reduces heat transfer, may be disposed between the power supply unit 30 and the cooling unit 20. In addition, heat insulating material may be disposed so as to surround the power supply unit 30.

The power supply unit 30 is configured to supply electric power to the cooling unit 20. The power supply unit 30 includes a battery 34 and a power conversion unit 35. The battery 34 is formed by a primary battery, such as a dry cell, or a secondary battery, such as a lithium-ion battery. The power conversion unit 35 converts direct-current power supplied from the battery 34 into any desired direct-current power and outputs the converted direct-current power to the cooling unit 20. The power conversion unit 35 is formed, for example, by a direct-current/direct-current (DC/DC) converter.

The operation unit 40 is a unit with which an input operation for the cooling device 100 is performed. The operation unit 40 is disposed on the upper surface of the front portion of the cooling device 100 seen in FIG. 1. The operation unit 40 is formed, for example, by mechanical switches, such as a rotary switch, a push switch, and a tactile switch, by touch switches that sense an input operation on the basis of a change in the capacitance of electrodes, or by other kinds of switches. Examples of an input operation from the operation unit 40 include turning on or off the power of the cooling device 100 and entering a cooling temperature level for the cooling unit 20. The operation unit 40 may include a display unit that indicates the operation status of the cooling device 100.

The control unit 50 controls the operation of the power conversion unit 35 in accordance with an input operation from the operation unit 40. The control unit 50 is formed by dedicated hardware or a CPU that executes programs stored in a memory. The term “CPU” is the abbreviated name for a central processing unit. A CPU is also referred to as a central processing device, a processing device, a computing device, a microprocessor, a microcomputer, or a processor.

When the control unit 50 is formed by dedicated hardware, examples of dedicated hardware forming the control unit 50 include a single circuit, a compound circuit, an ASIC, an FPGA, and a combination of these circuits. Each function unit provided by the control unit 50 may be provided by an individual piece of hardware, or all the function units may be provided by one piece of hardware. The term “ASIC” is the abbreviated name for an application specific integrated circuit. The term “FPGA” is the abbreviated name for a field-programmable gate array.

When the control unit 50 is formed by a CPU, each function performed by the control unit 50 is provided by software, firmware, or a combination of software and firmware. The software and firmware are described as programs and stored in a memory. The CPU provides functions of the control unit 50 by reading and executing the programs stored in the memory. Examples of the memory include an involatile or a volatile semiconductor memory, such as a RAM, a ROM, a flash memory, an EPROM, and an EEPROM.

Some of the functions of the control unit 50 may be provided by dedicated hardware, and some of the functions may be provided by software or firmware. The term “RAM” is the abbreviated name for a random access memory. The term “ROM” is the abbreviated name for a read only memory. The term “EPROM” is the abbreviated name for an erasable programmable read only memory. The term “EEPROM” is the abbreviated name for an electrically erasable programmable read-only memory.

The cooling unit 20 is configured to be driven by electric power supplied from the power supply unit 30 and to receive heat from the cooking container 5 (refer to FIG. 6). The cooling unit 20 is formed by components including a Peltier element, which is a thermoelectric element.

FIG. 4 is a side elevation view schematically depicting a configuration of the cooling unit of the cooling device according to Embodiment 1.

FIG. 5 is a plan view depicting the cooling unit of the cooling device according to Embodiment 1.

As depicted in FIGS. 4 and 5, the cooling unit 20 includes multiple pieces of P-type thermoelectric semiconductor 20a, multiple pieces of N-type thermoelectric semiconductor 20b, multiple electrodes 20c, and a pair of insulating parts 20d. The pair of insulating parts 20d are made of insulating material, such as ceramic. The pair of insulating parts 20d are each formed into a plate shape. The pair of insulating parts 20d are each formed into a ring shape to match the shape of the housing 10. The pair of insulating parts 20d are disposed to face each other.

The multiple pieces of P-type thermoelectric semiconductor 20a and the multiple pieces of N-type thermoelectric semiconductor 20b are disposed between the pair of insulating parts 20d, The pieces of P-type thermoelectric semiconductor 20a and the pieces of N-type thermoelectric semiconductor 20b are disposed alternately. An electrode 20c electrically connects a piece of P-type thermoelectric semiconductor 20a and a piece of N-type thermoelectric semiconductor 20b that are disposed side by side. A lead wire 20e is connected to an end portion of an electrode 20c, The other end of the lead wire 20e is connected to the power supply unit 30, and a direct-current voltage from the power supply unit 30 is applied to the other end of the lead wire 20e.

A piece of P-type thermoelectric semiconductor 20a, a piece of N-type thermoelectric semiconductor 20b, and an electrode 20c form a Peltier element. When a direct current flows in the electrode 20c, heat is generated or received at a contact surface between the electrode 20c and the piece of P-type thermoelectric semiconductor 20a or the piece of N-type thermoelectric semiconductor 20b. In this way, one part of the pair of insulating parts 20d, which is to become the cold side, is cooled, and the other part of the pair of insulating parts 20d, which is to become the hot side, is heated.

The housing 10 may accommodate the cooling unit 20 such that the insulating part 20d that is to become the cold side is exposed to form a portion of the surface of the housing 10. In this way, heat can be efficiently received by the insulating part 20d that is to become the cold side.

Of the pair of insulating parts 20d, with one insulating part 20d that is to become the hot side, a heat-removing means, such as a radiating fin, may be disposed in close contact. In this way, heat is easily removed from the insulating part 20d that is to become the hot side.

FIG. 6 is a longitudinal sectional view schematically depicting how the cooling device is placed according to Embodiment 1.

The cooling device 100 is attachable to and removable from the cooking container 5. For example, as depicted in FIG. 6, the cooling device 100 is placed on the upper surface of a lid 5a of the cooking container 5. The lower surface of the cooling unit 20 of the cooling device 100 that is to become the cold side is placed in close contact with the lid 5a of the cooking container 5 so as to face the upper surface of the lid 5a of the cooking container 5. When the cooling device 100 is placed on the upper portion of the cooking container 5, a handle 5b of the lid 5a is located inside the opening 11 of the housing 10.

The cooling device 100 may be placed in any position of the cooking container 5. For example, the cooling device 100 may be placed on the upper portion of the cooking container 5 without the lid 5a being placed on the upper portion of the cooking container 5. Alternatively, the cooling device 100 may be placed on the bottom surface of the cooking container 5.

The housing 10 may be formed into a plate shape without the opening 11 of the housing 10 of the cooling device 100.

The shape of the housing 10 of the cooling device 100 is not limited to a disc-like shape and may be any shape. For example, the shape may be a triangle, a quadrilateral, a polygonal shape having five sides or more, or an elliptical shape. In addition, the shape of the housing 10 of the cooling device 100 is not limited to a plate shape and may be hemispherical, cubic, or other three-dimensional shapes having curved faces of any kinds.

### (Operation)

Next, operations of the cooling device 100 according to Embodiment 1 will be described.

A user attaches the cooling device 100 to the cooking container 5 such that the cold-side face of the cooling unit 20 faces the cooking container 5.

Next, the user uses the operation unit 40 to perform an input operation to start cooling. The control unit 50 controls the operation of the power supply unit 30 in accordance with electric power set by the input operation from the operation unit 40. Examples of the input operation from the operation unit 40 include an input operation to select a cooling temperature level from three levels, for example, “weak”, “middle”, and “powerful”.

The control unit 50 controls the operation of the power supply unit 30 in accordance with the input operation from the operation unit 40. For example, the control unit 50 causes the direct-current power that is supplied to the cooling unit 20 to be turned on and off in accordance with the cooling temperature level. Specifically, when the cooling temperature level “powerful” is selected by the input operation, the control unit 50 causes the power supply unit 30 to continuously supply the direct-current power to the cooling unit 20. When the cooling temperature level “middle” is selected by the input operation, the control unit 50 causes the power supply unit 30 to periodically turn on and off the direct-current power supplied to the cooling unit 20. When the cooling temperature level “weak” is selected by the input operation, the control unit 50 causes the power supply unit 30 to periodically turn on and off the direct-current power supplied to the cooling unit 20 so as to keep the period during which the direct-current power is off longer than the period during which the direct-current power is off in a case where the cooling temperature level “middle” is selected.

When the direct-current power is supplied to the cooling unit 20, the cooking container 5, which faces the insulating part 20d that is to become the cold side, is cooled, and the food put into the cooking container 5 for cooking is cooled.

The above cooling operation by the cooling device 100 may be performed after the cooking container 5 is heated for cooking by a heating cooker. For example, the cooling device 100 is placed on the upper surface of the lid 5a of the cooking container 5 while the cooking container 5 is placed on the heating cooker. The heating cooker performs a heating operation to heat the bottom surface of the cooking container 5. The above cooling operation by the cooling device 100 may be performed after the heating operation by the heating cooker. In this way, the user need not move the cooking container 5 to perform the heating and cooling operations, leading to improved convenience.

As described above, in Embodiment 1, the cooling device 100 includes the cooling unit 20, which is configured to be driven by electric power and to receive heat, the power supply unit 30, which is configured to supply the electric power to the cooling unit 20, and the housing 10, which accommodates the cooling unit 20 and is attachable to and removable from the cooking container 5. Accordingly, the cooking container 5 of any kind can be cooled, leading to versatility improvement. Further, a cooling operation performed by the cooling device 100 after food is heated for cooking can reduce a time period required to cool the cooked food in the cooking container 5 to a temperature at which the cooked food is stored in a refrigerator. Thus, it is possible to reduce the spread of bacteria in the cooked food in this case, as compared with a case where the cooked food is left to cool by itself. Further, a cooling operation performed by the cooling device 100 after food is heated for cooking enables taste to penetrate into the cooked food in the cooking container 5, making the cooked food tastier.

Further, in Embodiment 1, the power supply unit 30 includes the battery 34, and the cooling unit 20 is configured to be driven by direct-current power supplied from the battery 34. Thus, a cable such as a power-supply cable with which to supply electric power to the cooling device 100 is unnecessary. Thus, when the cooling device 100 is attached to the cooking container 5, easy attachment and removal are possible without a nuisance caused by a cable such as a power-supply cable.

Further, in Embodiment 1, the power supply unit 30 includes the power conversion unit 35, which varies direct-current power supplied from the battery 34. Thus, the cooling temperature for the cooling unit 20 can be varied.

Further, in Embodiment 1, the cooling device 100 includes the operation unit 40, with which an input operation for the cooling device 100 is performed, and the control unit 50, which controls the operation of the power conversion unit 35 in accordance with the input operation from the operation unit 40. Thus, the cooling operation by the cooling unit 20 can be controlled in accordance with the input operation from the operation unit 40.

Further, in Embodiment 1, the housing 10 is formed into a disc-like shape. Thus, the shape of the housing 10 can be fit the shape of the upper portion of the cooking container 5, such as a cylindrical cooking pot that is widely available in the market, and the cooling unit 20 can efficiently receive heat. In addition, instead of the lid 5a of the cooking container 5, the cooling device 100 can be placed on the upper portion of the cooking container 5. Thus, the cooling unit 20 can efficiently receive heat.

In Embodiment 1, the power supply unit 30 is disposed at the outer perimeter portion of the housing 10, and the cooling unit 20 is disposed at the inner perimeter portion of the housing 10 and is located closer to the center of the housing 10 than is the power supply unit 30. The inner perimeter portion of the cooking container 5 tends to be at high temperature. As the cooling unit 20 is disposed along the inner perimeter of the cooking container 5, the cooling unit 20 can efficiently receive heat. In addition, the power supply unit 30 is less likely to be subjected to heat from the cooking container 5, Accordingly, degradation and damage of the power supply unit 30 caused by heat can be prevented.

Further, in Embodiment 1, the housing 10 has the opening 11, which is provided in the center. Accordingly, even when the handle 5b is disposed on the lid 5a of the cooking container 5, the cooling device 100 and the upper surface of the lid 5a can be made in close contact with each other. Thus, the cooling unit 20 can efficiently receive heat.

### (Modification 1)

FIG. 7 is a plan view depicting a cooling unit of a cooling device according to Modification 1 of Embodiment 1.

FIG. 8 is a plan view depicting the cooling device according to Modification 1 of Embodiment 1.

The housing 10 of the cooling device 100 may be made of flexible material. For example, the housing 10 is made of resin.

As depicted in FIGS. 7 and 8, the cooling device 100 includes multiple cooling units 20. Each of the multiple cooling units 20 has a rectangular shape. Each of the multiple cooling units 20 is formed, for example, into a rod-like shape. The multiple cooling units 20 are arranged radially from the center toward the outer perimeter of the housing 10. The multiple cooling units 20 are disposed such that the respective insulating parts 20d that are each to become the cold side face the same surface of the housing 10.

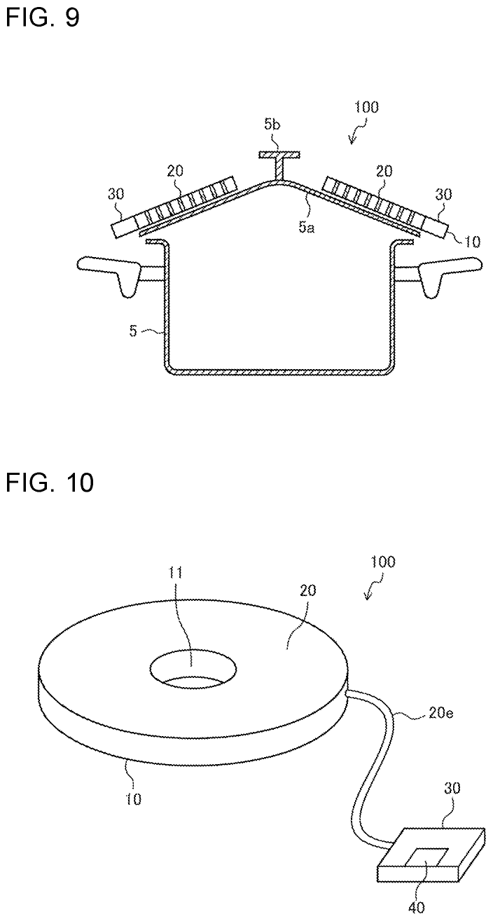

FIG. 9 is a side elevation view schematically depicting how the cooling device is placed according to Modification 1 of Embodiment 1.

In a case where the lid 5a of the cooking container 5 has a shape projecting upward as depicted in FIG. 9, the housing 10 of the cooling device 100, which is flexible, deforms along the shape of the lid 5a and is disposed such that the lower surface of the housing 10 is in close contact with the upper surface of the lid 5a. In addition, since being arranged radially from the center toward the outer perimeter of the housing 10, the multiple cooling units 20 are disposed along the slope from the center toward the outer perimeter of the lid 5a.

Such a configuration enables the cooling device 100 to be closely attached to the cooking container 5 even when the lid 5a of the cooking container 5 is not planar. Thus, the cooling unit 20 can efficiently receive heat.

### (Modification 2)

FIG. 10 is a perspective view depicting a cooling device according to Modification 2 of Embodiment 1.

The housing 10 of the cooling device 100 at least needs to accommodate the cooling unit 20. In other words, at least one of the power supply unit 30 and the operation unit 40 may be disposed separately from the housing 10.

For example, as depicted in FIG. 10, the power supply unit 30 and the operation unit 40 are disposed separately from the housing 10, and the power supply unit 30 and the cooling unit 20 are connected by using the lead wire 20e.

Because of such a configuration, the power supply unit 30 is less likely to be subjected to heat from the cooking container 5. Accordingly, degradation and damage of the power supply unit 30 caused by heat can be prevented.

### (Modification 3)

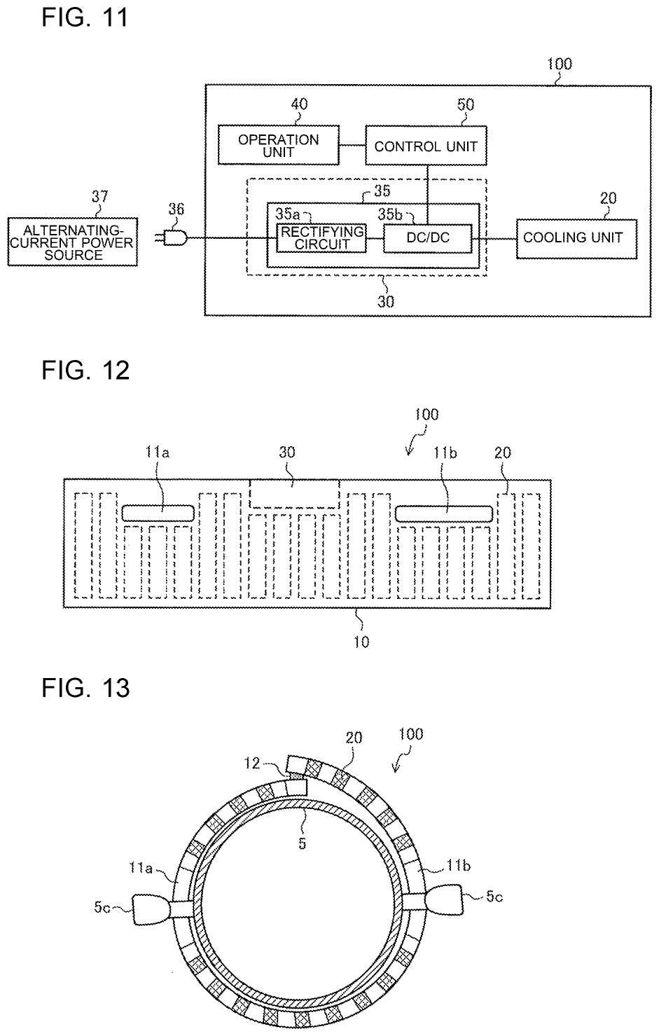

FIG. 11 is a block diagram depicting a configuration of a cooling device according to Modification 3 of Embodiment 1.

As depicted in FIG. 11, the cooling device 100 is provided with a plug 36 to be connected to an alternating-current power source 37. The power supply unit 30 includes the power conversion unit 35, which converts, into direct-current power, alternating-current power supplied from the alternating-current power source 37 via the plug 36. The power conversion unit 35 includes a rectifying circuit 35a, which generates direct-current power by rectifying alternating-current power, and a DC/DC converter 35b, which converts the direct-current power generated by the rectifying circuit 35a by rectification into any direct-current power and outputs the converted direct-current power to the cooling unit 20. The cooling unit 20 is configured to be driven by direct-current power supplied from the power conversion unit 35.

Such a configuration avoids battery exhaustion during a cooling operation and enables a cooling operation to continue for a longer period compared with a configuration with which electric power is supplied from the battery 34.

### (Modification 4)

The cooling device 100 may include a temperature sensor configured to sense the temperature of the cooking container 5. The control unit 50 may control electric power supplied from the power supply unit 30 to the cooling unit 20 depending on the temperature sensed by the temperature sensor.

For example, an operation of a set temperature is input from the operation unit 40. The control unit 50 controls the cooling unit 20 such that the temperature sensed by the temperature sensor is the same as the set temperature. Specifically, when the temperature sensed by the temperature sensor is lower than the set temperature, the control unit 50 turns off direct-current power that is supplied from the power supply unit 30 to the cooling unit 20. Further, when the temperature sensed by the temperature sensor is higher than or equal to the set temperature, the control unit 50 turns on direct-current power that is supplied from the power supply unit 30 to the cooling unit 20. Control of the cooling unit 20 by the control unit 50 is not limited to the control described above, and any temperature control may be adopted. For example, the control unit 50 may perform control such that the on-duty ratio of the power supply unit 30 is increased as the temperature difference between the set temperature and the temperature sensed by the temperature sensor (the set temperature<the temperature sensed by the temperature sensor) increases.

In Embodiment 1 described above, a configuration including the operation unit 40 and the control unit 50 has been described, but both the operation unit 40 and the control unit 50 may be removed from the configuration. For example, the power conversion unit 35 may convert electric power that is output from the battery 34 into predetermined electric power and supply the converted electric power to the cooling unit 20. Further, the power conversion unit 35 may be removed, and electric power that is output from the battery 34 may be directly supplied to the cooling unit 20. In addition, an on-off switch may be disposed to turn on and off electric power supplied from the battery 34 to the cooling unit 20.

### Embodiment 2

A description will be given below of a configuration of a cooling device 100 according to Embodiment 2, focusing on differences from Embodiment 1.

FIG. 12 is a plan view depicting the cooling device according to Embodiment 2.

A housing 10 is made of flexible material. For example, the housing 10 is made of resin. As depicted in FIG. 12, the housing 10 of the cooling device 100 is formed into a belt-like shape. For example, the housing 10 is formed into a rectangular plate. The housing 10 has a longitudinal length longer than the circumference of a cooking container 5, such as a cooking pot that is widely available in the market.

The housing 10 has an opening 11a and an opening 11b. The opening 11a and the opening 11b each have a rectangular shape elongated in the longitudinal direction of the housing 10. The opening 11a and the opening 11b are provided at positions shifted from the center toward an edge of the housing 10 in the transverse direction. At least one opening is provided in the housing 10. A configuration with no opening in the housing 10 may also be adopted.

The cooling device 100 includes multiple cooling units 20. Each of the multiple cooling units 20 has a rectangular shape. Each of the multiple cooling units 20 is formed, for example, into a rod-like shape. The multiple cooling units 20 are arranged side by side in the longitudinal direction of the housing 10. The multiple cooling units 20 are disposed such that the respective insulating parts 20d that are each to become the cold side face the same surface of the housing 10. A power supply unit 30 is disposed near an edge in the transverse direction of the housing 10.

FIG. 13 is a cross-sectional view schematically depicting how the cooling device is placed according to Embodiment 2.

FIG. 14 is a longitudinal sectional view schematically depicting how the cooling device is placed according to Embodiment 2.

As depicted in FIGS. 13 and 14, the cooling device 100 is placed so as to surround the outer side surface of the cooking container 5. In other words, the housing 10, which is flexible, is deformed so as to run along the outer side surface of the cooking container 5, and the cooling device 100, which is attachable to and removable from the cooking container 5, is attached so as to surround the outer perimeter of the cooking container 5. A holding means 12, such as a magnet or a hook, may be disposed near an end in the longitudinal direction of the housing 10 so as to keep the housing 10 deformed to run along the side surface of the cooking container 5.

A surface of the cooling unit 20 of the cooling device 100 that is to become the cold side is placed in close contact with the side surface of the cooking container 5 so as to face the side surface of the cooking container 5. When the cooling device 100 is attached to the side surface of the cooking container 5, handles 5c disposed on the side surface of the cooking container 5 are located inside the opening 11a and the opening 11b of the housing 10.

When the cooling device 100 is attached to the side surface of the cooking container 5, the power supply unit 30 is located at the upper portion of the cooking container 5.

As described above, in Embodiment 2, the housing 10 is formed into a band-like shape and made of flexible material. Such a configuration enables the cooling device 100 to be closely attached to the side surface of the cooking container 5. Thus, the cooling unit 20 can efficiently receive heat.

In Embodiment 2, the multiple cooling units 20 are arranged side by side in the longitudinal direction of the housing 10. Such a configuration enables the housing 10 to easily deform to run along the side surface of the cooking container 5 even when the cooling units 20 are made of inflexible material.

In Embodiment 2, the power supply unit 30 is disposed near an edge in the transverse direction of the housing 10. And, when the cooling device 100 is attached to the side surface of the cooking container 5, the power supply unit 30 is located at the upper portion of the cooking container 5. Consequently, the power supply unit 30 is less likely to be subjected to heat even when the bottom surface of the cooking container 5 is heated by a heating cooker. Accordingly, degradation and damage of the power supply unit 30 caused by heat can be prevented.

Further, in Embodiment 2, the housing 10 has at least one opening 11. Accordingly, even when the handle 5c is disposed on the side surface of the cooking container 5, the cooling device 100 and the side surface of the cooking container 5 can be made in close contact with each other. Thus, the cooling unit 20 can efficiently receive heat.

### (Modification 1)

FIG. 15 is a perspective view depicting a cooling device according to Modification 1 of Embodiment 2. Only a relevant portion of the cooling device 100 is depicted in FIG. 15.

As depicted in FIG. 15, the housing 10 may be formed into a shape having both a band-like portion 13 formed into a band-like shape and a protruding portion 14 that protrudes from an edge in the transverse direction of the band-like portion 13 and that extends in a direction intersecting the band-like portion 13. For example, in the cross-sectional view along the transverse direction of the housing 10, the protruding portion 14 is formed so as to extend in the direction perpendicular to the band-like portion 13 from an edge in the transverse direction of the band-like portion 13. The cooling units 20 are disposed in the band-like portion 13, and the power supply unit 30 is disposed in the protruding portion 14.

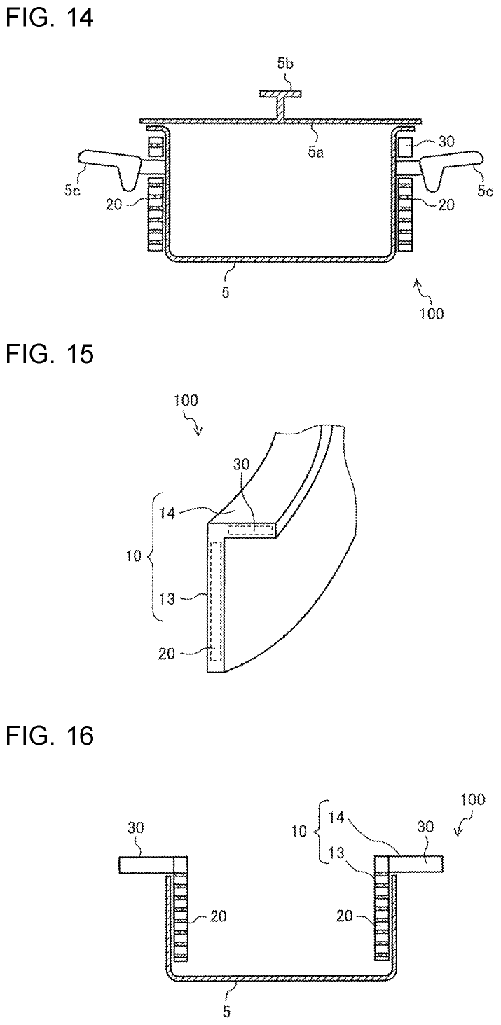

FIG. 16 is a longitudinal sectional view schematically depicting how the cooling device is placed according to Modification 1 of Embodiment 2.

As depicted in FIG. 16, the band-like portion 13 of the housing 10 of the cooling device 100 is placed inside the cooking container 5 so as to run along the inner side surface of the cooking container 5. In addition, a surface of the cooling unit 20 of the cooling device 100 that is to become the cold side is placed in close contact with the side surface of the cooking container 5 so as to face the center of the cooking container 5. Further, the protruding portion 14 of the housing 10 of the cooling device 100 is placed on the upper end of the surrounding wall of the cooking container 5. In other words, the band-like portion 13 of the housing 10 of the cooling device 100, which is flexible, is deformed so as to run along the inner side surface of the cooking container 5, and the protruding portion 14 of the housing 10 supports the cooling device 100 on the surrounding wall of the cooking container 5. In this way, the cooling device 100, which is attachable to and removable from the cooking container 5, is attached to the cooking container 5.

The housing 10 is formed watertight and prevents cooked food in liquid form in the cooking container 5 from flowing into the housing 10.

Such a configuration enables the cooling device 100 to be attachable to and removable from the inner portion of the cooking container 5. Thus, as the cooling device 100 and cooked food in the cooking container 5 can be in close contact with each other, the cooling unit 20 can efficiently receive heat. Further, since being disposed in the protruding portion 14 of the housing 10, the power supply unit 30 is less likely to be subjected to heat even when the cooking container 5 is heated by a heating cooker. Accordingly, degradation and damage of the power supply unit 30 caused by heat can be prevented.

### (Modification 2)

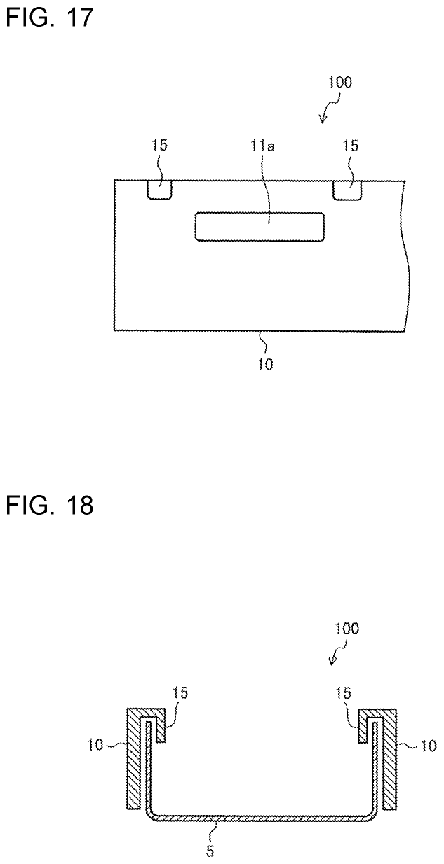

FIG. 17 is a plan view depicting a cooling device according to Modification 2 of Embodiment 2. Only a relevant portion of the cooling device 100 is depicted in FIG. 17. Further, the cooling unit 20 is not depicted in FIG. 17.

As depicted in FIG. 17, holding means 15 may be disposed near an edge in the transverse direction of the housing 10. The holding means 15 are used to support the housing 10 on the side surface of the cooking container 5. The holding means 15, for example, protrude from an edge in the transverse direction of the housing 10, extending in a direction perpendicular to a surface of the housing 10, and are each formed into a hook-like shape bending toward the other edge in the transverse direction of the housing 10, The holding means 15 are formed for example, together with the housing 10. Multiple holding means 15 may be disposed near an edge of the housing 10.

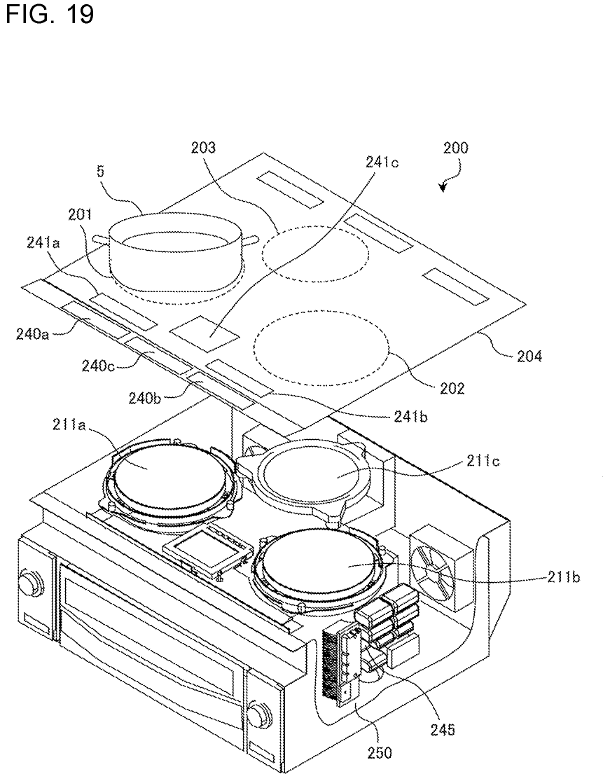

FIG. 18 is a longitudinal sectional view schematically depicting how the cooling device is placed according to Modification 2 of Embodiment 2.

As depicted in FIG. 18, the holding means 15 are used to support the housing 10 of the cooling device 100 on the outer side surface of the cooking container 5. In other words, the housing 10 of the cooling device 100, which is flexible, is deformed so as to run along the outer side surface of the cooking container 5, and the holding means 15 support an edge portion of the housing 10 on the surrounding wall of the cooking container 5. In this way, the cooling device 100, which is attachable to and removable from the cooking container 5, is attached to the cooking container 5.

The cooling device 100 according to Modification 2 may be placed inside the cooking container 5 so as to run along the inner surface of the cooking container 5.

Such a configuration enables the cooling device 100 to be attachable to and removable from the side surface of the cooking container 5. Thus, since the cooling device 100 and the side surface of the cooking container 5 can be in close contact with each other, the cooling unit 20 can efficiently receive heat. In addition, since the holding means 15 support the housing 10 on the cooking container 5, the cooling device 100 is easily attached to and removed from the cooking container 5.

### Embodiment 3

A configuration and operations of a cooking system according to Embodiment 3 will be described below.

The cooking system includes a cooling device 100 and an induction heating cooker 200. The induction heating cooker 200 is configured to function as a non-contact power transmission device and to transmit electric power to the cooling device 100 in a non-contact manner. A description regarding a configuration of the cooling device 100 according to Embodiment 3 will focus on differences from Embodiment 1 and Embodiment 2, which have been described above.

### (Configuration)

FIG. 19 is an exploded perspective view depicting the induction heating cooker of the cooking system according to Embodiment 3.

As depicted in FIG. 19, the induction heating cooker 200 includes a top plate 204 in the upper portion of the body, and a cooking container 5, such as a cooking pot, is placed on the top plate 204. The top plate 204 includes a first stovetop 201 and a second stovetop 202 as heating areas on which the cooking container 5 is heated through induction. The first stovetop 201 and the second stovetop 202 are disposed side by side in the lateral direction on the front portion of the top plate 204. The induction heating cooker 200 also includes a third stovetop 203 as a third heating area. The third stovetop 203 is disposed behind the first stovetop 201 and the second stovetop 202 and substantially in the center of the top plate 204 in the lateral direction.

A heating coil 211a, a heating coil 211b, and a heating coil 211c are disposed under the first stovetop 201, the second stovetop 202, and the third stovetop 203, respectively. The heating coils 211a, 211b, and 211c are used to heat the cooking container 5, which is placed on one of the stovetops. Each of the heating coils 211a, 211b, and 211c is referred to simply as a heating coil 211 in the following description when the heating coils need not be distinguished.

The top plate 204 is entirely made of material that transmits infrared light, such as heat-resistant tempered glass and glass-ceramics. In addition, a circular pot-positioning mark that corresponds to a heating area of a heating coil 211 for each stovetop is formed on the top plate 204 by painting, printing, or other methods to roughly indicate a position where a cooking pot is to be placed.

A main-body operation unit 240 is disposed on the front portion of the top plate 204. The main-body operation unit 240 is an input device with which to set an input power, a cooking recipe, or other settings when the cooking container 5 or other pots and pans are heated by the heating coil 211 for each stovetop. In Embodiment 3, the main-body operation unit 240 is divided into a main-body operation unit 240a, a main-body operation unit 240b, and a main-body operation unit 240c, each of which corresponds to a heating unit.

Further, as a reporting means, a main-body display unit 241 is disposed near the main-body operation unit 240. The main-body display unit 241 displays operation status of each heating unit, input from the main-body operation unit 240, an operation detail, and other information. In Embodiment 3, the main-body display unit 241 is divided into a main-body display unit 241a, a main-body display unit 241b, and a main-body display unit 241c, each of which corresponds to a heating unit.

The main-body operation unit 240 and the main-body display unit 241 may be divided and provided individually for each heating unit as described above, or may be each provided as a single unit that covers all the heating units. The main-body operation unit 240 and the main-body display unit 241 are not limited to the above configurations and may be provided in other configurations. The main-body operation unit 240 herein is formed, for example, by mechanical switches, such as a push switch and a tactile switch, by touch switches that sense an input operation on the basis of a change in the capacitance of electrodes, or by other kinds of switches. The main-body display unit 241 is formed, for example, by an LCD, an LED, or other kinds of display devices.

The main-body operation unit 240 and the main-body display unit 241 may be combined and provided as a single operation-display unit. An operation-display unit is formed, for example, by a touch panel having touch switches on an LCD or by other kinds of devices. The term “LCD” is the abbreviated name for a liquid crystal device. The term “LED” is the abbreviated name for a light emitting diode.

The induction heating cooker 200 includes an inverter circuit 250 and a main-body control unit 245, which are disposed inside the induction heating cooker 200. The inverter circuit 250 is configured to supply high-frequency power to the heating coil 211. The main-body control unit 245 controls the entire operation of the induction heating cooker 200 including the inverter circuit 250.

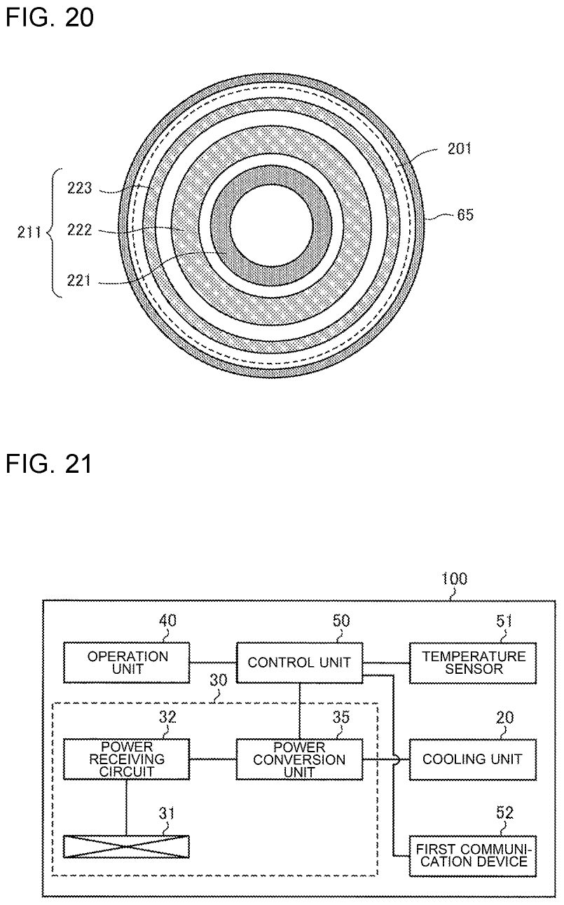

FIG. 20 is a plan view depicting a heating coil and a power transmitting coil of the induction heating cooker according to Embodiment 3.

The heating coil 211 is formed by multiple ring-shaped concentric coils having different diameters. FIG. 20 depicts an example of the heating coil 211 that has three ring-shaped coils. The heating coil 211 includes an inner coil 221 disposed at the center of the first stovetop 201, and a middle coil 222 disposed around the outer perimeter of the inner coil 221, and an outer coil 223 disposed around the outer perimeter of the middle coil 222.

A conductive wire made of a metal wire having an insulating sheath is coiled and formed into each of the inner coil 221, the middle coil 222, and the outer coil 223. The conductive wire may be made of any metal, such as copper and aluminum. The inner coil 221, the middle coil 222, and the outer coil 223 are each formed by an individually wound coil.

Further, as depicted in FIG. 20, a power transmitting coil 65 is disposed under the top plate 204 of the induction heating cooker 200 and is configured to transmit electric power to the cooling device 100 through magnetic resonance. A conductive wire made of a metal wire having an insulating sheath is coiled and formed into the power transmitting coil 65. The conductive wire may be made of any metal, such as copper and aluminum. The power transmitting coil 65 is formed to have a smaller inductance than an inductance of the heating coil 211.

The power transmitting coil 65 is disposed so as to surround the heating coil 211 in plan view. For example, the power transmitting coil 65 is disposed around the outer perimeter of the outer coil 223. The power transmitting coil 65 is disposed so as to form a circle concentric to the inner coil 221, the middle coil 222, and the outer coil 223.

The shape and position of the power transmitting coil 65 is not limited to the above example. For example, multiple power transmitting coils 65 may be disposed. Alternatively, the power transmitting coil 65 may be disposed so as to surround in plan view the heating coils 211a, 211b, and 211c, which correspond to the stovetops.

FIG. 21 is a block diagram depicting a configuration of the cooling device according to Embodiment 3.

The cooling device 100 according to Embodiment 3 receives electric power from the induction heating cooker 200 in a non-contact manner. The cooling device 100 according to Embodiment 3 includes a first communication device 52 and a temperature sensor 51 in addition to the configuration in Embodiment 1 described above. Further, a power supply unit 30 of the cooling device 100 according to Embodiment 3 includes a power receiving coil 31 and a power receiving circuit 32.

The power receiving coil 31 receives electric power from the power transmitting coil 65 through magnetic resonance. A conductive wire made of a metal wire having an insulating sheath is coiled and formed into the power receiving coil 31. The conductive wire may be made of any metal, such as copper and aluminum. The power receiving circuit 32 is configured to supply electric power received by the power receiving coil 31 to a power conversion unit 35. Details will be described below.

A cooling unit 20, a control unit 50, the first communication device 52, and the temperature sensor 51 are configured to be driven by electric power supplied from the power receiving circuit 32.

The temperature sensor 51 is formed, for example, by an infrared sensor and senses the temperature of the cooking container 5, to which the cooling device 100 is attached. The temperature sensor 51 may be formed by a contact-type sensor, such as a thermistor. The temperature sensor 51 outputs to the control unit 50 a voltage signal corresponding to a sensed temperature.

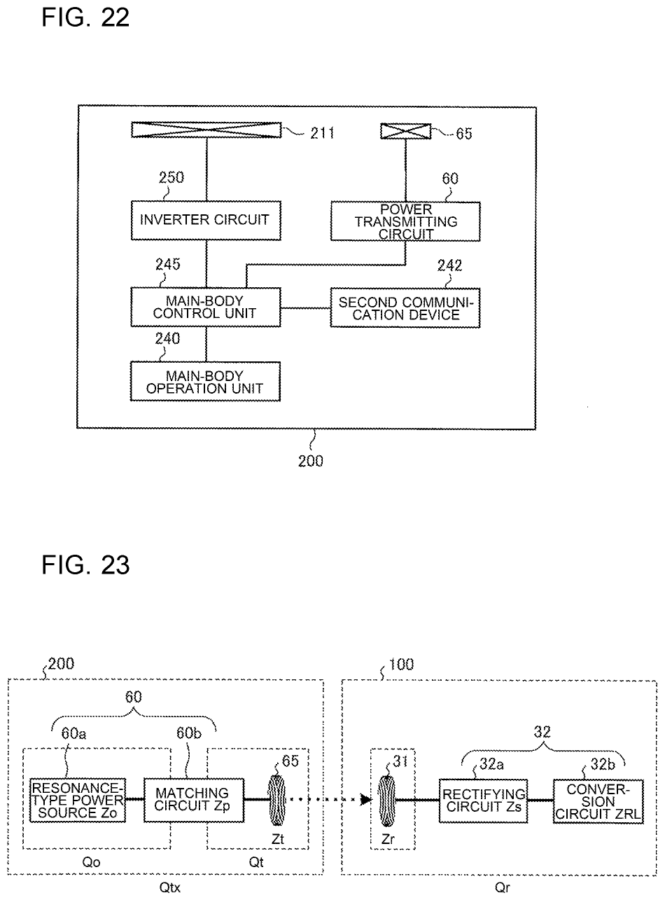

The control unit 50 causes the first communication device 52 to transmit information on a temperature sensed by the temperature sensor 51. The first communication device 52 is formed by a wireless communication interface suitable for any communication standard, such as wireless LAN, Bluetooth (registered trademark), infrared communication, and NFC. The first communication device 52 wirelessly communicates with a second communication device 242 of the induction heating cooker 200 (refer to FIG. 22). The term “LAN” is the abbreviated name for local area network. The term “NFC” is the abbreviated name for near field communication.

FIG. 22 is a block diagram depicting a configuration of the induction heating cooker according to Embodiment 3.

As depicted in FIG. 22, the induction heating cooker 200 includes the heating coil 211, the inverter circuit 250, the main-body control unit 245, the main-body operation unit 240, the second communication device 242, a power transmitting circuit 60, and the power transmitting coil 65.

The main-body control unit 245 controls the inverter circuit 250 in accordance with an operation detail received from the main-body operation unit 240 and communication information received from the second communication device 242. In addition, the main-body control unit 245 causes the main-body operation unit 240 to display information depending on operation status or other conditions.

The main-body control unit 245 is formed by dedicated hardware or a CPU that executes programs stored in a memory. When the main-body control unit 245 is formed by dedicated hardware, examples of dedicated hardware forming the main-body control unit 245 include a single circuit, a compound circuit, an ASIC, an FPGA, and a combination of these circuits. Each function unit provided by the main-body control unit 245 may be provided by an individual piece of hardware, or all the function units may be provided by one piece of hardware. When the main-body control unit 245 is formed by a CPU, each function performed by the main-body control unit 245 is provided by software, firmware, or a combination of software and firmware. The software and firmware are described as programs and stored in a memory. The CPU provides functions of the main-body control unit 245 by reading and executing the programs stored in the memory. Some of the functions of the main-body control unit 245 may be provided by dedicated hardware, and some of the functions may be provided by software or firmware.

The inverter circuit 250 converts alternating-current power supplied from an alternating-current power source into high-frequency alternating-current power having a frequency in the range of approximately 20 kHz to 100 kHz and outputs the high-frequency alternating-current power to the heating coil 211. In response to the high-frequency alternating-current power supplied from the inverter circuit 250 to the heating coil 211, a high-frequency current of several tens of amperes flows through the heating coil 211. A high-frequency magnetic flux generated by the high-frequency current flowing through the heating coil 211 heats through induction the cooking container 5, which is placed on the top plate 204 directly above the heating coil 211.

The second communication device 242 is formed by a wireless communication interface suitable for the communication standard adopted by the first communication device 52. The second communication device 242 wirelessly communicates with the first communication device 52 of the cooling device 100.

The power transmitting circuit 60 is configured to supply electric power to the power transmitting coil 65. Details will be described below,

### (Power Transmission by Magnetic Resonance Method)

FIG. 23 is a diagram depicting a configuration of the cooling device and the induction heating cooker of the cooking system according to Embodiment 3.

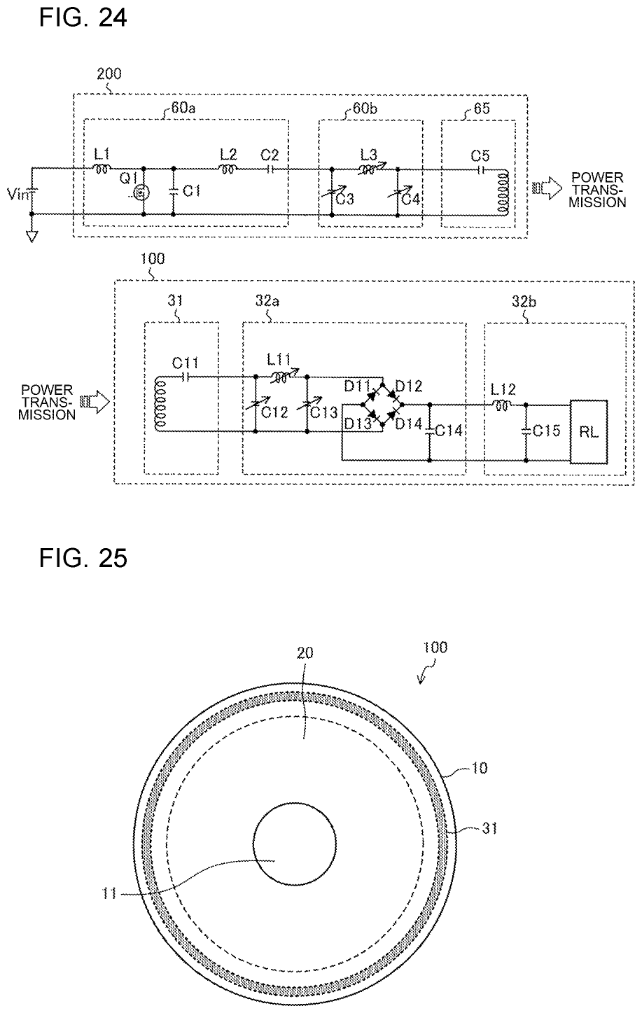

FIG. 24 is a specific circuit diagram of the configuration depicted in FIG. 23.

The configuration of the induction heating cooker 200 and the cooling device 100 depicted in FIGS. 23 and 24 are related to power transmission by a magnetic resonance method.

The induction heating cooker 200 and the cooling device 100 form a magnetic-resonance type (resonance-coupling type) non-contact power transmission system that is configured to transmit electric power by using resonance characteristics. In other words, the induction heating cooker 200 forms a resonance-type power transmission device that is configured to transmit electric power to the cooling device 100 through magnetic resonance. The cooling device 100 forms a resonance-type power receiving device that receives electric power from the induction heating cooker 200 through magnetic resonance.

As depicted in FIGS. 23 and 24, the power transmitting circuit 60 of the induction heating cooker 200 is formed by a resonance-type power source 60a and a matching circuit 60b.

The resonance-type power source 60a, which controls electric power to be supplied to the power transmitting coil 65, converts direct- or alternating-current input power into alternating-current power having a predetermined frequency and outputs the alternating-current power having the predetermined frequency. The resonance-type power source 60a is formed by a power-supply circuit of a resonance-switching type and has an output impedance Zo, a resonant frequency fo, and a resonance characteristic value Qo.

The resonant frequency fo of the resonance-type power source 60a is set at a frequency in a MHz frequency band. The resonant frequency fo is, for example, 6.78 MHz. The resonant frequency fo is not limited to this value and may be set at a frequency of an integer multiple of 6.78 MHz in the MHz frequency band.

The matching circuit 60b performs impedance matching to match the output impedance Zo of the resonance-type power source 60a to a transmission characteristic impedance Zt of the power transmitting coil 65. The matching circuit 60b is formed by a π- or an L-type filter including an inductor L and a capacitor C and has a transmission characteristic impedance Zp.

The power transmitting coil 65 is configured to receive alternating-current power from the resonance-type power source 60a via the matching circuit 60b, to perform a resonance operation, and to generate a non-radiative electromagnetic field in the neighborhood. In this way, the power transmitting coil 65 is configured to transmit electric power to the power receiving coil 31 of the cooling device 100. A resonant circuit is formed by a coil and a capacitor C5 in the power transmitting coil 65, which is used as a resonance-type antenna. The power transmitting coil 65 has the transmission characteristic impedance Zt, a resonant frequency ft, and a resonance characteristic value Qt.

The resonant frequency fo and the resonance characteristic value Qo of the resonance-type power source 60a are determined by the output impedance Zo of the resonance-type power source 60a and the transmission characteristic impedance Zp of the matching circuit 60b. The resonant frequency ft and the resonance characteristic value Qt of the power transmitting coil 65 are determined by the transmission characteristic impedance Zt of the power transmitting coil 65 and the transmission characteristic impedance Zp of the matching circuit 60b.

Then, the induction heating cooker 200 has a resonance characteristic value Qtx given by mathematical formula (1) and calculated by using these two resonance characteristic values Qo and Qt.

[Math. 1]

Qtx=√(Qo·Qt) (1)

The power receiving circuit 32 of the cooling device 100 is formed by a rectifying circuit 32a and a conversion circuit 32b.

The power receiving coil 31 performs a resonance-coupling operation with a non-radiative electromagnetic field generated by the power transmitting coil 65 and receives electric power. Then, the power receiving coil 31 outputs alternating-current power. A resonant circuit is formed by a coil and a capacitor C11 in the power receiving coil 31, which is used as a resonance-type antenna. The power receiving coil 31 has a transmission characteristic impedance Zr.

The rectifying circuit 32a is a matching-type rectifying circuit having a rectifying function and a matching function. The rectifying function converts alternating-current power from the power receiving coil 31 into direct-current power, and the matching function performs impedance matching to match the transmission characteristic impedance Zr of the power receiving coil 31 to an input impedance ZRL of the conversion circuit 32b. The matching function is provided by a π- or an L-type filter including an inductor L and a capacitor C. The rectifying circuit 32a has a transmission characteristic impedance Zs. The rectifying circuit 32a is herein configured to have a rectifying function and a matching function by way of non-limiting example. The rectifying circuit 32a may have only a rectifying function although rectifying efficiency decreases.

The conversion circuit 32b receives direct-current power from the rectifying circuit 32a and converts the direct-current power into direct-current power having a predetermined voltage, which is then supplied to a load circuit (such as the cooling unit 20). The conversion circuit 32b is formed by an LC filter (smoothing filter) to smooth high-frequency voltage ripples, a DC/DC converter to convert direct-current power into direct-current power having a predetermined voltage, and other components and has the input impedance ZRL. The conversion circuit 32b may be formed only by the smoothing filter without the DC/DC converter.

The resonance characteristic value Qr and the resonant frequency fr of the cooling device 100 are determined by the transmission characteristic impedance Zr of the power receiving coil 31, the transmission characteristic impedance Zs of the rectifying circuit 32a, and the input impedance ZRL of the conversion circuit 32b.

The characteristic impedance of each function unit is determined such that the resonance characteristic value Qo of the resonance-type power source 60a, the resonance characteristic value Qt of the power transmitting coil 65, and the resonance characteristic value Qr of the cooling device 100 have a certain relationship. Specifically, the characteristic impedance of each function unit is determined such that the resonance characteristic value Qtx(=√(Qo·Ot)) of the induction heating cooker 200 is close to the resonance characteristic value Qr of the cooling device 100 (refer to mathematical formula (2) below).

More specifically, Qtx is desirably set in the range specified by mathematical formula (3) below.

[Math. 2]

√(Qo·Qt)=Qr (2)

[Math. 3]

0.5Qr≤√(Qo·Qt)≤1.5Qr (3)

In this way, a decrease in power transmission efficiency can be avoided by establishing such a relationship as is described above between the three resonance characteristic values, that is, the resonance characteristic value Qo of the resonance-type power source 60a, the resonance characteristic value Qt of the power transmitting coil 65, and the resonance characteristic value Qr of the cooling device 100. Accordingly, power transmission caused by the magnetic resonance method (resonance-coupling type) allows the power transmitting coil 65 and the power receiving coil 31 to be placed farther apart than power transmission caused by an electromagnetic induction method (electromagnetic-induction-coupling type).

FIG. 25 is a plan view depicting the cooling device according to Embodiment 3. FIG. 25 depicts a plan view in a case where the cooling device 100 is viewed from a surface of the cooling unit 20 of the cooling device 100 that is to become the cold side, that is, the surface facing the cooking container 5.

As depicted in FIG. 25, a housing 10 accommodates the power receiving coil 31. The power receiving coil 31 is formed into a circular shape whose circumference running along the outer perimeter of the housing 10, which is formed into a disc-like shape. The power receiving coil 31 is disposed outside the cooling unit 20.

The shape and position of the power receiving coil 31 is not limited to the above example. For example, multiple power receiving coils 31 may be disposed. Alternatively, the power receiving coil 31 may be disposed separately from the housing 10. For example, the power supply unit 30 having the power receiving coil 31 may be disposed separately from the housing 10, and the power supply unit 30 and the cooling unit 20 may be connected by using a lead wire 20e.

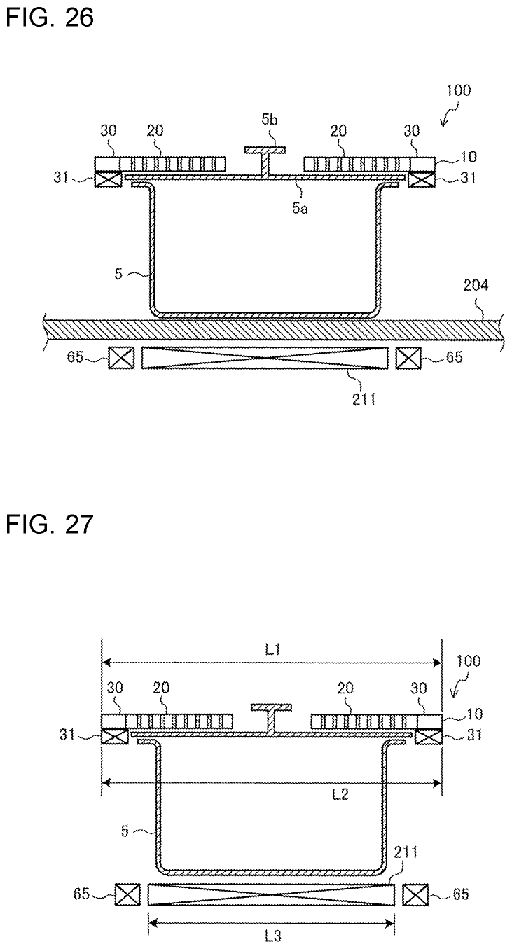

FIG. 26 is a longitudinal sectional view schematically depicting how the cooling device is placed according to Embodiment 3. FIG. 26 depicts a situation in which the cooking container 5 is placed on the top plate 204 of the induction heating cooker 200.

As depicted in FIG. 26, the cooling device 100 is placed on the upper surface of a lid 5a of the cooking container 5. The lower surface of the cooling unit 20 of the cooling device 100 that is to become the cold side is placed in close contact with the lid 5a of the cooking container 5 so as to face the upper surface of the lid 5a of the cooking container 5. When the cooling device 100 is placed on the upper portion of the cooking container 5, a handle 5b of the lid 5a is located inside an opening 11 of the housing 10. In addition, the power receiving coil 31, which is disposed at the outer perimeter portion of the housing 10, is disposed above the power transmitting coil 65, which is disposed so as to surround the heating coil 211.

As depicted in FIG. 26, the power receiving coil 31 of the cooling device 100 is desirably formed so as to have an outer diameter larger than the outer diameter of the cooking container 5, such as a cooking pot that is widely available in the market. Since the power receiving coil 31 is formed so as to have an outer diameter lamer than the outer diameter of the cooking container 5, the cooking container 5 is unlikely to act as a shield between the power receiving coil 31 and the power transmitting coil 65.

A description will be given herein of a relationship between the outer diameter L1 of the housing 10, the outer diameter L2 of the power receiving coil 31, and the outer diameter L3 of the heating coil 211.

FIG. 27 is a diagram describing the sizes of the housing and the power receiving coil of the cooling device and the size of the heating coil of the induction heating cooker in the cooking system according to Embodiment 3. The top plate 204 is not depicted in FIG. 27.

As depicted in FIG. 27, the cooling device 100 is formed such that the outer diameter L1 of the housing 10 is larger than the outer diameter L3 of the heating coil 211. The cooking container 5, which has an outer diameter smaller than the outer diameter L3 of the heating coil 211, is widely available in the market for induction heating by the induction heating cooker 200. Accordingly, when the housing 10 is formed so as to have the outer diameter L1 larger than the outer diameter L3 of the heating coil 211, the outer diameter L1 of the housing 10 is likely to be larger than the outer diameter of the cooking container 5, which is heated through induction. Since the housing 10 is formed so as to have the outer diameter L1 larger than the outer diameter of the cooking container 5, the cooling device 100 can be placed stably on the upper portion of the cooking container 5. In addition, since the power supply unit 30, which is disposed at the outer perimeter portion of the housing 10, and the cooking container 5 can be placed apart, the power supply unit 30 is less likely to be subjected to heat from the cooking container 5.

The cooling device 100 is formed such that the outer diameter L2 of the power receiving coil 31 is larger than the outer diameter L3 of the heating coil 211. Accordingly, the outer diameter L3 of the heating coil 211 is likely to be larger than the outer diameter of the cooking container 5, which is heated through induction. Thus, the cooking container 5 is unlikely to act as a shield between the power receiving coil 31 and the power transmitting coil 65.

### (Operation)

Next, operations of the cooking system according to Embodiment 3 will be described. The description will be given separately for a heating operation in which the cooking container 5 is heated through induction and for a cooling operation in which the cooking container 5 is cooled.

### [Heating Operation]

A user places the cooking container 5, such as a cooking pot, on a stovetop of the top plate 204 of the induction heating cooker 200. The user uses the main-body operation unit 240 to perform an input operation to start heating. The main-body control unit 245 controls the operation of the inverter circuit 250 in accordance with electric power set by the input operation from the main-body operation unit 240. For example, in accordance with the electric power that is set, the main-body control unit 245 varies the frequency of a high-frequency current supplied from the inverter circuit 250 to the heating coil 211.

In response to a high-frequency current flowing through the heating coil 211, a high-frequency magnetic field is generated. Then, an eddy current flows in the direction to cancel the change in magnetic flux in the bottom of the cooking container 5, and the cooking container 5 is heated by a loss of the eddy current that flows.

### [Cooling Operation]

The user attaches the cooling device 100 to the cooking container 5 such that the cold-side face of the cooling unit 20 faces the cooking container 5.

Next, the user uses the main-body operation unit 240 to perform an input operation to start cooling. Examples of the input operation from the main-body operation unit 240 include an input operation to select a cooling temperature level from three levels, for example, “weak”, “middle”, and “powerful”, and an operation to input a value to set the temperature of the cooking container 5.

In response to the input operation performed by the main-body operation unit 240 to start cooling, the main-body control unit 245 drives the power transmitting circuit 60 to start supplying electric power to the power transmitting coil 65. In this way, electric power is supplied from the power transmitting coil 65 to the power receiving coil 31 of the cooling device 100 through magnetic resonance. The main-body control unit 245 also controls the operation of the power transmitting circuit 60 in accordance with an input operation from the main-body operation unit 240. For example, in accordance with the cooling temperature level, the main-body control unit 245 controls the magnitude of the electric power supplied from the power transmitting circuit 60 to the power transmitting coil 65.

Alternating-current power received by the power receiving coil 31 is converted into direct-current power by the power receiving circuit 32. The direct-current power that is output from the power receiving coil 31 is varied by the power conversion unit 35 and subsequently supplied to the cooling unit 20. When the direct-current power is supplied to the cooling unit 20, the cooking container 5, which faces an insulating part 20d that is to become the cold side, is cooled.

The temperature sensor 51 of the cooling device 100 senses the temperature of the cooking container 5. The control unit 50 causes the first communication device 52 to transmit information on the temperature sensed by the temperature sensor 51.

The second communication device 242 of the induction heating cooker 200 receives the information on the temperature that is transmitted from the first communication device 52, and outputs the information on the temperature to the main-body control unit 245. The main-body control unit 245 of the induction heating cooker 200 controls driving of the power transmitting circuit 60 depending on the information on the temperature acquired from the temperature sensor 51 of the cooling device 100.

Specifically, the main-body control unit 245 controls the power transmitting circuit 60 such that the temperature sensed by the temperature sensor 51 is the same as the set temperature. When the temperature sensed by the temperature sensor 51 is lower than the set temperature, the main-body control unit 245 turns off electric power that is supplied from the power transmitting circuit 60 to the power transmitting coil 65. Further, when the temperature sensed by the temperature sensor 51 is higher than or equal to the set temperature, the main-body control unit 245 increases electric power that is supplied from the power transmitting circuit 60 to the power transmitting coil 65. Control of the power transmitting circuit 60 by the main-body control unit 245 is not limited to the control described above, and any temperature control may be adopted. For example, the main-body control unit 245 may perform control such that the electric power supplied from the power transmitting circuit 60 to the power transmitting coil 65 is increased as the temperature difference between the set temperature and the temperature sensed by the temperature sensor 51 (the set temperature<the temperature sensed by the temperature sensor 51) increases.

The heating operation and the cooling operation, which have been described above, may be performed in parallel or may be performed successively. As depicted, for example, in FIG. 26, the user places the cooking container 5 on a stovetop of the top plate 204 and attaches the cooling device 100 to the upper portion of the lid 5a of the cooking container 5. With this configuration, the cooking system may perform in parallel the heating operation by the heating coil 211 of the induction heating cooker 200 and the cooling operation by the cooling unit 20 of the cooling device 100. Alternatively, for example, with the cooking container 5 being placed on a stovetop of the top plate 204 and the cooling device 100 being attached to the upper portion of the lid 5a of the cooking container 5, the cooking system may perform the heating operation and the cooling operation successively or alternately.

As described above, the cooking system includes the cooling device 100 and the induction heating cooker 200 in Embodiment 3. The induction heating cooker 200 includes the heating coil 211, which is configured to heat the cooking container 5 through induction, the inverter circuit 250, which is configured to supply a high-frequency current to the heating coil 211, the power transmitting coil 65, which is configured to transmit electric power through magnetic resonance, and the power transmitting circuit 60, which is configured to supply electric power to the power transmitting coil 65. The power supply unit 30 of the cooling device 100 includes the power receiving coil 31, which is configured to receive electric power through magnetic resonance, and the power conversion unit 35, which is configured to convert the electric power received by the power receiving coil 31 into direct-current power. The cooling unit 20 is configured to be driven by the direct-current power supplied from the power conversion unit 35.

This configuration prevents battery exhaustion from occurring during the cooling operation and enables the cooling operation to continue for a longer period compared with a configuration with which electric power is supplied from a battery. In addition, a cable such as a power-supply cable with which to supply electric power to the cooling device 100 is unnecessary. Thus, when the cooling device 100 is attached to the cooking container 5, easy attachment and removal are possible without a nuisance caused by a cable such as a power-supply cable.

Since the cooking system can perform the heating operation and the cooling operation in parallel or successively, cooling and heating can be coordinated to cook the food in the cooking container 5. Further, the cooling operation performed after the heating operation enables taste to penetrate into the cooked food in the cooking container 5, making the cooked food tastier. In addition, the cooling operation performed after the heating operation can reduce a time period required to cool the cooked food in the cooking container 5 to a temperature at which the cooked food is stored in a refrigerator. Thus, it is possible to reduce the spread of bacteria in the cooked food in this case, as compared with a case where the cooked food is left to cool by itself.

Further, while the cooking container 5 is placed on a stovetop of the top plate 204, the cooling device 100 can be attached to the cooking container 5. Consequently, after food is heated for cooking by the induction heating cooker 200, the cooling operation can be performed by the cooling device 100 without the need to move the cooking container 5. Thus, the heating operation and the cooling operation can be easily coordinated.

In Embodiment 3, there is provided the main-body control unit 245, which controls the power transmitting circuit 60 in accordance with an input operation from the main-body operation unit 240. Consequently, an operation by the cooling unit 20, such as the start and stop of the cooling operation by the cooling device 100, can be easily set by the main-body operation unit 240 of the induction heating cooker 200.

In Embodiment 3, the cooling device 100 includes the temperature sensor 51 and the first communication device 52. The temperature sensor 51 is configured to sense the temperature of the cooking container 5, and the first communication device 52 is configured to transmit information on the temperature sensed by the temperature sensor 51. The induction heating cooker 200 includes the second communication device 242 and the main-body control unit 245. The second communication device 242 receives the information on the temperature that is transmitted from the second communication device 242, and the main-body control unit 245 controls the operation of the power transmitting circuit 60 depending on the information on the temperature. Consequently, the temperature can be precisely controlled in the cooling operation on the basis of a sensing signal from the temperature sensor 51.

In Embodiment 3, the power receiving coil 31 receives electric power from the power transmitting coil 65 through magnetic resonance. Thus, restrictions on the position at which the cooling device 100, to which electric power is transmitted from the induction heating cooker 200, is disposed can be less severe, as compared with power transmission through electromagnetic-induction coupling.

For example, in a case of power transmission through electromagnetic-induction coupling, as the frequency used for power transmission is close to the frequency of a coil current that flows through the heating coil 211, malfunctions occur in some cases because the magnetic field due to power transmission through electromagnetic-induction coupling and the magnetic field generated by the heating coil 211 interfere with each other. Accordingly, in the case of power transmission through electromagnetic-induction coupling, it is difficult to provide induction heating and power transmission simultaneously. Thus, in the case of power transmission through electromagnetic-induction coupling, induction heating needs to be lowered in input power or needs to be stopped temporarily to avoid malfunctions.

In contrast, in a case of the cooking system according to Embodiment 3, since electric power is transmitted through magnetic resonance, induction heating neither needs to be lowered in input power nor needs to be stopped. Thus, an easy-to-use cooking system can be provided.

Further, for example, in the case of power transmission through electromagnetic-induction coupling, when the power transmitting coil and the power receiving coil are misaligned with each other, power transmission efficiency considerably decreases. Thus, in the case of power transmission through electromagnetic-induction coupling, an excessive current flows through the power transmitting coil, leading to an increase in heat generation in the power transmitting coil. A further increase in misalignment prevents power transmission to the power receiving device.

In contrast, since the cooking system according to Embodiment 3 performs power transmission through magnetic resonance, even when the power transmitting coil 65 and the power receiving coil 31 are misaligned with each other, that is, even when the power transmitting coil 65 and the power receiving coil 31 are not placed to face each other, electric power is stably transmitted.

In Embodiment 3, the resonant frequency of magnetic resonance is a frequency in a MHz band. For example, the driving frequency for the inverter circuit 250 is higher than or equal to 20 kHz and lower than 100 kHz, and the resonant frequency of magnetic resonance is equal to 6.78 MHz or an integer multiple of 6.78 MHz.

In this way, since the resonant frequency for the power transmission through magnetic resonance significantly differs from the frequency of the coil current that flows through the heating coil 211, the power transmission from the induction heating cooker 200 to the cooling device 100 is not affected by the magnetic field generated by the coil current that flows through the heating coil 211. Accordingly, electric power can be stably transmitted irrespective of the magnitude of the coil current, that is, the magnitude of electric power that is input. In addition, induction heating of the cooking container 5 and power transmission to the cooling device 100 can be performed simultaneously. Further, a conductor (metal) placed on the top plate 204 is not heated through induction by the magnetic field generated by the power transmitting coil 65. For example, even when a metal utensil or other metal tools are placed on the top plate 204, those metal tools are not heated through induction by the magnetic field generated by the power transmitting coil 65.

In addition, since the resonant frequency of magnetic resonance is much higher than the frequency of the high-frequency current that flows through the heating coil 211, the inductance of the power transmitting coil 65 can be made much smaller than the inductance of the heating coil 211. Consequently, a magnetic substance, such as a ferrite, is not required for the power transmitting coil 65. Thus, the induction heating cooker 200 can be downsized and available at a reduced price.

### (Modification 1)

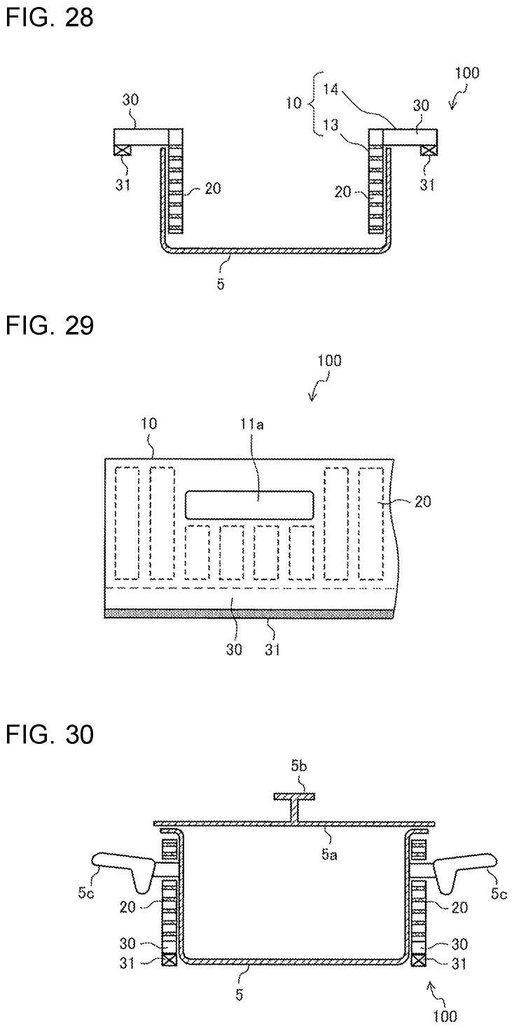

FIG. 28 is a longitudinal sectional view schematically depicting how a cooling device is placed according to Modification 1 of Embodiment 3.

Similarly to the housing 10 according to Embodiment 2, which is described above, the housing 10 of the cooling device 100 may be formed into a belt-like shape and made of flexible material. As depicted in FIG. 28, the housing 10 may be formed into a shape having both a band-like portion 13 formed into a band-like shape and a protruding portion 14 that protrudes from an edge in the transverse direction of the band-like portion 13 and that extends in a direction intersecting the band-like portion 13. For example, in the cross-sectional view along the transverse direction of the housing 10, the protruding portion 14 is formed so as to extend in the direction perpendicular to the band-like portion 13 from an edge in the transverse direction of the band-like portion 13. The cooling units 20 are disposed in the band-like portion 13, and the power supply unit 30, which is provided with the power receiving coil 31, is disposed at the protruding portion 14.

Because of such a configuration, when the cooling device 100 is placed inside the cooking container 5, the power supply unit 30, which is disposed at the protruding portion 14 of the housing 10, is located outside the surrounding wall of the cooking container 5. Consequently, since the power receiving coil 31 of the power supply unit 30 is located outside the surrounding wall of the cooking container 5, the cooking container 5 is unlikely to act as a shield between the power receiving coil 31 and the power transmitting coil 65. Further, since being disposed at the protruding portion 14 of the housing 10, the power supply unit 30, which is provided with the power receiving coil 31, is less likely to be subjected to heat even when the cooking container 5 is heated by a heating cooker. Accordingly, degradation and damage of the power supply unit 30, which is provided with the power receiving coil 31, caused by heat can be prevented.

### (Modification 2)

FIG. 29 is a plan view depicting a cooling device according to Modification 2 of Embodiment 3. Only a relevant portion of the cooling device 100 is depicted in FIG. 29.

As depicted in FIG. 29, the power supply unit 30, which includes the power receiving coil 31, may be disposed near an edge in the transverse direction of the housing 10.

FIG. 30 is a longitudinal sectional view schematically depicting how the cooling device is placed according to Modification 2 of Embodiment 3.

As depicted in FIG. 30, the cooling device 100 is placed so as to surround the outer side surface of the cooking container 5. When the cooling device 100 is attached to the side surface of the cooking container 5, the power supply unit 30, which includes the power receiving coil 31, is located on the lower portion of the cooking container 5.

Such a configuration enables the power transmitting coil 65 and the power receiving coil 31 to be placed close while the cooking container 5 is placed on the induction heating cooker 200, leading to efficient non-contact power transmission.

### (Modification 3)

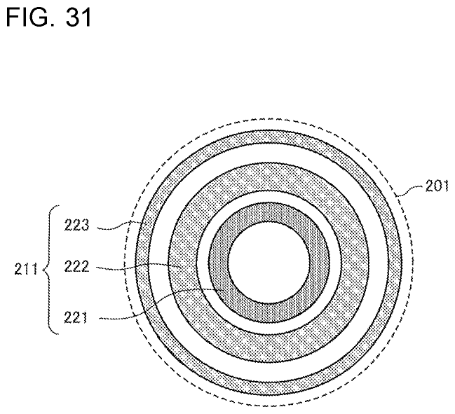

FIG. 31 is a plan view depicting a heating coil of an induction heating cooker according to Modification 3 of Embodiment 3.

The power receiving coil 31 may be formed to receive electric power from the heating coil 211 through electromagnetic induction. The induction heating cooker 200 may be formed without the power transmitting circuit 60 and the power transmitting coil 65. Specifically, as depicted in FIG. 31, only the heating coil 211, which is formed by the inner coil 221, the middle coil 222, and the outer coil 223, may be disposed under the first stovetop 201 of the top plate 204.

For example, the cooking container 5, which has an intermediate diameter, is placed above the inner coil 221 and the middle coil 222, and when the cooling device 100 according to Modification 2, which is described above, is attached to the side surface of the cooking container 5, the power receiving coil 31 and the outer coil 223 are placed to face each other.

In the cooling operation, the user uses the main-body operation unit 240 to perform an input operation to start cooling. In response to the input operation performed by the main-body operation unit 240 to start cooling, the main-body control unit 245 drives the inverter circuit 250 to start supplying electric power to the outer coil 223. In response to a high-frequency current being supplied from the inverter circuit 250 to the outer coil 223, a high-frequency magnetic flux originates from the outer coil 223. In response to the high-frequency magnetic flux originating from the outer coil 223, electric power due to electromagnetic induction is generated in the power receiving coil 31 of the cooling device 100. In this way, electric power is supplied from the outer coil 223 to the power receiving coil 31 of the cooling device 100 through electromagnetic induction.

The main-body control unit 245 also controls the operation of the inverter circuit 250 in accordance with an input operation from the main-body operation unit 240. For example, in accordance with the cooling temperature level, the main-body control unit 245 controls the magnitude of the electric power supplied from the inverter circuit 250 to the outer coil 223.

The main-body control unit 245 also controls driving of the inverter circuit 250 depending on information on a temperature acquired from the temperature sensor 51 of the cooling device 100. Specifically, the main-body control unit 245 controls the inverter circuit 250 such that the temperature sensed by the temperature sensor 51 is the same as the set temperature. When the temperature sensed by the temperature sensor 51 is lower than the set temperature, the main-body control unit 245 turns off electric power that is supplied to the outer coil 223, which faces the power receiving coil 31. Further, when the temperature sensed by the temperature sensor 51 is higher than or equal to the set temperature, the main-body control unit 245 increases electric power that is supplied to the outer coil 223, which faces the power receiving coil 31.

In this way, electric power is transmitted through electromagnetic induction from the heating coil 211 of the induction heating cooker 200 to the power receiving coil 31 of the cooling device 100, and the induction heating cooker 200 may be formed without the power transmitting circuit 60 and the power transmitting coil 65, leading to a simplified configuration.

### REFERENCE SIGNS LIST

5: cooking container, 5a: lid, 5b: handle, 5c: handle, 10: housing, 11: opening, 11a: opening, 11b: opening, 12: holding means, 13: band-like portion, 14: protruding portion, 15: holding means, 20: cooling unit, 20a: P-type thermoelectric semiconductor, 20b: N-type thermoelectric semiconductor, 20c: electrode, 20d: insulating part, 20e: lead wire, 30: power supply unit, 31: power receiving coil, 32: power receiving circuit, 32a: rectifying circuit, 32b: conversion circuit, 34: battery, 35: power conversion unit, 35a: rectifying circuit, 35b: DC/DC converter, 36: plug, 37: alternating-current power source, 40: operation unit, 50: control unit, 51: temperature sensor, 52: first communication device, 60: power transmitting circuit, 60a: resonance-type power source, 60b: matching circuit, 65: power transmitting con, 100: cooling device, 200: induction heating cooker, 201: first stovetop, 202: second stovetop, 203: third stovetop, 204: top plate, 211: heating coil, 211a: heating coil, 211b: heating coil, 211c: heating coil, 221: inner coil, 222: middle coil, 223: outer coil, 240: main-body operation unit, 240a: main-body operation unit, 240b: main-body operation unit, 240c: main-body operation unit, 241: main-body display unit, 241a: main-body display unit, 241b: main-body display unit, 241c: main-body display unit, 242: second communication device, 245: main-body control unit, 250: inverter circuit

1. A cooling device, comprising:
a cooling unit configured to be driven by electric power and to receive heat;
a power supply unit configured to supply the electric power to the cooling unit; and
a housing that accommodates the cooling unit and is attachable to a cooking container and removable from the cooking container,
the housing
being formed into a disc-like shape, and
being made of flexible material.

2. The cooling device of claim 1,
wherein the power supply unit includes a battery, and
the cooling unit is configured to be driven by direct-current power supplied from the battery.

3. The cooling device of claim 2,
wherein the power supply unit includes
a power conversion unit configured to vary the direct-current power supplied from the battery.

4. The cooling device of claim 1,
wherein the power supply unit includes
a power conversion unit configured to convert alternating-current power supplied from an alternating-current power source into direct-current power, and
the cooling unit is configured to be driven by direct-current power supplied from the power conversion unit.

5. The cooling device of claim 1,
wherein the power supply unit includes
a power receiving coil configured to receive electric power through magnetic resonance or through electromagnetic induction, and
a power conversion unit configured to convert electric power received by the power receiving coil into direct-current power, and
the cooling unit is configured to be driven by direct-current power supplied from the power conversion unit.

6. The cooling device of claim 3, comprising:
an operation unit with which an input operation for the cooling device is performed, and
a control unit configured to control an operation of the power conversion unit in accordance with an input operation from the operation unit.

7. The cooling device of claim 1,
wherein the cooling unit includes a Peltier element.

8. (canceled)

9. (canceled)

10. The cooling device of claim 1,
wherein the cooling unit includes a plurality of thermoelectric elements each having a rectangular shape, and
the plurality of thermoelectric elements are arranged radially from a center of the housing toward an outer perimeter of the housing.

11. The cooling device of claim 1,
wherein the power supply unit is disposed at an outer perimeter portion of the housing, and
the cooling unit is disposed at an inner perimeter portion of the housing and is located closer to a center of the housing than is the power supply unit.

12. The cooling device of claim 1,
wherein the housing has an opening that is provided in a center of the housing.

13. (canceled)

14. The cooling device of claim 16,
wherein the cooling unit includes a plurality of thermoelectric elements, and
the plurality of thermoelectric elements are arranged side by side in a longitudinal direction of the housing.

15. (canceled)

16. A cooling device, comprising:
a cooling unit configured to be driven by electric power and to receive heat;
a power supply unit configured to supply the electric power to the cooling unit; and
a housing that accommodates the cooling unit and is attachable to a cooking container and removable from the cooking container,
the housing being formed into a band-like shape and made of flexible material,
the power supply unit including
a power receiving coil configured to receive electric power through magnetic resonance or through electromagnetic induction, and
a power conversion unit configured to convert electric power received by the power receiving coil into direct-current power,
the cooling unit being configured to be driven by direct-current power supplied from the power conversion unit,
the power receiving coil being disposed near an edge in a transverse direction of the housing.

17. (canceled)

18. The cooling device of claim 16,
wherein the housing has at least one opening.

19. The cooling device of claim 16, comprising
a holding means that holds the housing on a side surface of the cooking container.

20. A cooking system, comprising:
the cooling device of claim 5; and
an induction heating cooker,
wherein the induction heating cooker includes
a heating coil configured to heat the cooking container through induction, and
an inverter circuit configured to supply a high-frequency current to the heating coil, and
the power receiving coil is configured to receive electric power from the heating coil through electromagnetic induction.

21. The cooking system of claim 20,
wherein the induction heating cooker includes
a main-body operation unit with which an input operation for the cooling device is performed, and
a main-body control unit configured to control an operation of the inverter circuit in accordance with an input operation from the main-body operation unit.

22. The cooking system of claim 20,
wherein the cooling device includes a temperature sensor configured to sense a temperature of the cooking container, and
a first communication device configured to transmit information on a temperature sensed by the temperature sensor, and
the induction heating cooker includes
a second communication device configured to receive the information on the temperature that is transmitted from the first communication device, and
a main-body control unit configured to control an operation of the inverter circuit depending on the information on the temperature.

23. A cooking system, comprising:
the cooling device of claim 5; and
an induction heating cooker,
wherein the induction heating cooker includes
a heating coil configured to heat the cooking container through induction,
an inverter circuit configured to supply a high-frequency current to the heating coil,
a power transmitting coil configured to transmit electric power through magnetic resonance, and
a power transmitting circuit configured to supply electric power to the power transmitting coil, and
the power receiving coil is configured to receive electric power from the power transmitting coil through magnetic resonance.

24. The cooking system of claim 23,
wherein the induction heating cooker includes
a main-body operation unit with which an input operation for the cooling device is performed, and
a main-body control unit configured to control an operation of the power transmitting circuit in accordance with an input operation from the main-body operation unit.

25. The cooking system of claim 23,
wherein the cooling device includes a temperature sensor configured to sense a temperature of the cooking container, and
a first communication device configured to transmit information on a temperature sensed by the temperature sensor, and
the induction heating cooker includes
a second communication device configured to receive the information on the temperature that is transmitted from the first communication device, and
a main-body control unit configured to control an operation of the power transmitting circuit depending on the information on the temperature.

26. The cooking system of claim 20,
wherein an outer diameter of the power receiving coil is larger than an outer diameter of the heating coil.

27. A cooking system, comprising:
the cooling device of claim 1; and
an induction heating cooker,
wherein the induction heating cooker includes
a heating coil configured to heat the cooking container through induction, and
an outer diameter of the housing of the cooling device is larger than an outer diameter of the heating coil.
